(19) United States
(12) Patent Application Publication
(10) Pub. No.: US 2011/0238383 A1
(43) Pub. Date: Sep. 29, 2011

(54) One-Port De-embedding Using Time Domain Substitution

(76) Inventor: Donald W. Metzger, Colorado Springs, CO (US)

(21) Appl. No.: 13/048,008

(22) Filed: Mar. 15, 2011

Related U.S. Application Data
(60) Provisional application No. 61/316,731, filed on Mar. 23, 2010.

(51) Int. Cl. G06F 19/00

(52) U.S. Cl. 702/196

(57) ABSTRACT

A method is provided for de-embedding the S-parameter response of an electrical DUT embedded in an electrical network. The method comprises making first and second S-parameter measurements in the frequency domain at a port or measurement reference plane to the network containing the DUT. For the second measurement, a known impedance condition is created at the embedded location of the DUT. The first and second measurements are transformed to the time domain, and then gated to select portions of the time-domain-transformed responses that correspond to paths that include the DUT and known impedance condition, respectively. The gated time domain responses are then transformed back into the frequency domain, yielding first and second selected S-parameter measurement responses M1 and M2, respectively. A reflection S-parameter for the DUT is then determined as a function of the first and second selected S-parameter measurement responses and the known impedance condition.

### RELATED APPLICATIONS

This application claims priority to and herein incorporates by reference U.S. Provisional Patent Application No. 61/316,731, filed on Mar. 23, 2010, entitled “One Port Device De-embedding for Network Analyzers Using Time Domain Processing.”

### FIELD OF THE INVENTION

This invention relates generally to the use of vector network analyzers (VNAs), and more particularly, to de-embedding the response of the device under test (DUT) from the measurements that include the intervening physical components between the VNA and the DUT.

### BACKGROUND

Vector Network Analyzers (VNAs) are radio frequency (RF) measurement systems used to determine the scattering parameters (commonly referred to as “S-parameters”) of a device under test (DUT). A VNA generates a single frequency, continuous wave (CW) stimulus signal. This signal is sent through cables to a DUT. The stimulus and the DUT response signals are measured by the VNA. A new stimulus signal is then generated at a different frequency. The response of the DUT is similarly determined for this new frequency. This process continues over a range of frequencies. The result is the response of the DUT at multiple frequencies. These results are termed frequency domain responses, because the measured data is a function of the stimulus frequency.

The foregoing measured responses, however, are distorted by the intrinsic electrical characteristics (e.g., capacitance, inductance, resistance) of the physical components (e.g., VNA cables and printed circuit board) between the VNA and the DUT. Errors caused by the VNA cables can be removed from these measured signals through a relatively easy process called correction. But, as explained below, the conventional process for removing errors caused by other elements, such as an intervening printed circuit board, is much more tedious and difficult. Often, calibration kits are not available for such elements. Consequently, users often fail to perform the needed corrections.

A common VNA measurement problem involves making one port, S₁₁ measurements of a device where there is intervening circuitry between the measurement point and the device. A signal flow graph of this measurement is shown in FIG. 3. It is desired to measure the transfer function D (for DUT). However, there are intervening physical elements between the measurement points at a₁ and b₁ and the device location at D. Those intervening elements are modeled as the L, a two port network, and P, a transmission line. This is a very general model which can fit many actual measurement scenarios.

When a network analyzer measures the S₁₁ of this network, it measures:

$${S}_{11} = \frac{{b}_{1}}{{a}_{1}} = {L}_{11} + \frac{{L}_{12} {L}_{21} {P}^{2} D}{1 - {L}_{22} {P}^{2} D} \qquad ( 1 )$$

The parameter D is desired, but the intervening circuitry introduces complexity into the equation which involves all of the terms in the model. Solving for D requires knowing L₁₁, L₁₂, L₂₁, L₂₂, and P. In the language of VNAs, the problem of extracting D from the measured value of S11 is known as de-embedding. Where the measurement involves only one port, the problem is known more fully as one-port de-embedding.

One current approach to this problem involves the insertion of various known devices (calibration standards) at the location D. Measurements with these known standards can be used to characterize the intervening circuitry between the VNA and the DUT. This process is called calibration. This approach requires that multiple calibration standards be inserted and measured, a time consuming process. In addition, the creation of those multiple standards can be a difficult task. At least three calibration standards need to be inserted and measured. Using the results of this calibration to remove the effects of the intervening circuitry is called correction.

### SUMMARY

A novel method is provided for de-embedding the S-parameter response of an electrical DUT embedded in an electrical network. The method relies on a combination of key insights.

The first insight is that a signal fed by a VNA to a DUT produces multiple reflections, each corresponding to a different propagation path for the signal, spaced apart in time. These reflections can be isolated by transforming the S-parameter response to the time domain, applying a gate to select a portion of the response corresponding to a particular path, and transforming the gated response back into the frequency domain.

The second insight is that no matter which individual path is chosen, the path equations characterizing the signals through that path will always be defined as a string of products, which is more readily and easily solved than equation (1).

The third insight is that by substituting a single known impedance condition at the location of the DUT, and making an otherwise identical measurement, inverse transformation, gating, and forward transformation, the S-parameter response of the DUT can be solved as a function of the two measurements and the known impedance condition.

Accordingly, the method comprises making first and second S-parameter measurements in the frequency domain at a port or measurement reference plane to the network containing the DUT. For the second measurement, a known impedance condition is created at the embedded location of the DUT. The first and second measurements are transformed to the time domain, and then gated to select portions of the time-domain-transformed responses that correspond to paths that include the DUT and known impedance condition, respectively. The gated time domain responses are then transformed back into the frequency domain, yielding first and second selected S-parameter measurement responses M1 and M2, respectively. A reflection S-parameter for the DUT is then determined as a function of the first and second selected S-parameter measurement responses and the known impedance condition.

These and other aspects, features, and advantages of the present invention will be readily apparent to those skilled in the art from the following detailed description taken in conjunction with the annexed sheets of drawings, which illustrate the invention. The invention, however, is not limited by systems with any particular combination of the described features, aspects, and advantages, except and to the extent specifically so limited by the claims.

### BRIEF DESCRIPTION OF THE DRAWINGS

FIG. 1 illustrates one embodiment of a common test configuration for a device under test.

FIG. 2 illustrates one embodiment of an electrical network model for a device under test.

FIG. 3 illustrates one embodiment of a signal flow graph for modeling the measurement of a one-port device.

FIG. 4 illustrates a first impulse response through the signal flow graph of FIG. 3.

FIG. 5 illustrates a second impulse response through the signal flow graph of FIG. 3.

FIG. 6 illustrates the substitution of a known impedance condition or device K at the location of the DUT in the signal flow graph of FIG. 3.

FIG. 7 is a flow chart of one embodiment of a method of de-embedding the scattering response of an electrical device under test embedded in an electrical network.

### DETAILED DESCRIPTION

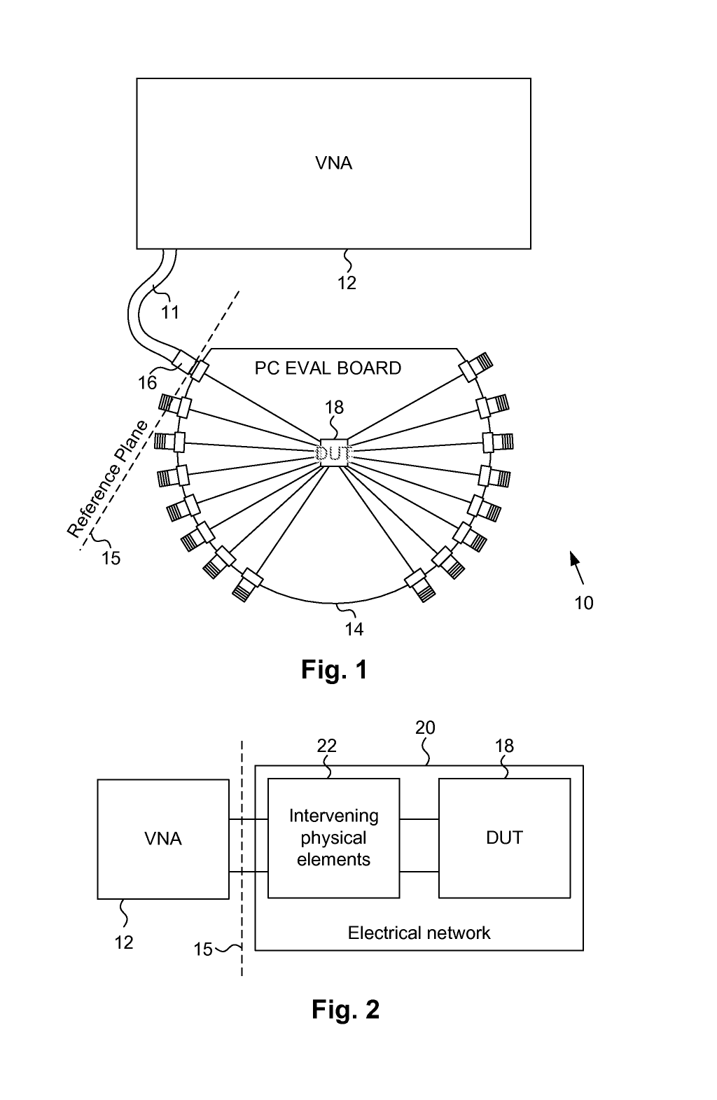

FIG. 1 illustrates one embodiment of a common test configuration 10 for a device under test (DUT). The DUT 18 is embedded in an evaluation board 14 with radially-extending coaxial cable connectors for transferring signals to and from each of the pins of the DUT 18. A vector network analyzer (VNA) 12 is connected, via a coaxial cable, to one of the coaxial inputs 16 of the evaluation board 14.

Typically, the VNA will be calibrated at the cable ends, to correct scattering parameter measurements for errors introduced by the coaxial cable 11 and the VNA 12. But as illustrated in FIGS. 1 and 2, there is frequently additional circuitry (e.g., wire) between the measurement point—also referred to as the reference plane 15—and the DUT 18.

FIG. 2 illustrates one embodiment of an electrical network model that is applicable to any test configuration in which the measurement reference plane 15 is remote from the DUT 18. The test configuration is modeled as a VNA 12 connected to an electrical network 20 containing the DUT 18. Signals transmitted between the reference plane 15 and the DUT 18 pass through intervening physical elements 22 with inherent electrical properties (e.g., capacitance, inductance, resistance). The challenge is to de-embed the scattering response of the DUT from the measured scattering response at the reference plane.

The present invention approaches de-embedding through a novel process referred to herein as time domain substitution. A key insight of this novel process is the recognition that a signal fed by a VNA to a DUT produces multiple reflections, spaced apart in time. Each reflection corresponds to a different propagation path for the signal. The reflections are spaced apart in time because propagation through different paths takes different amounts of time.

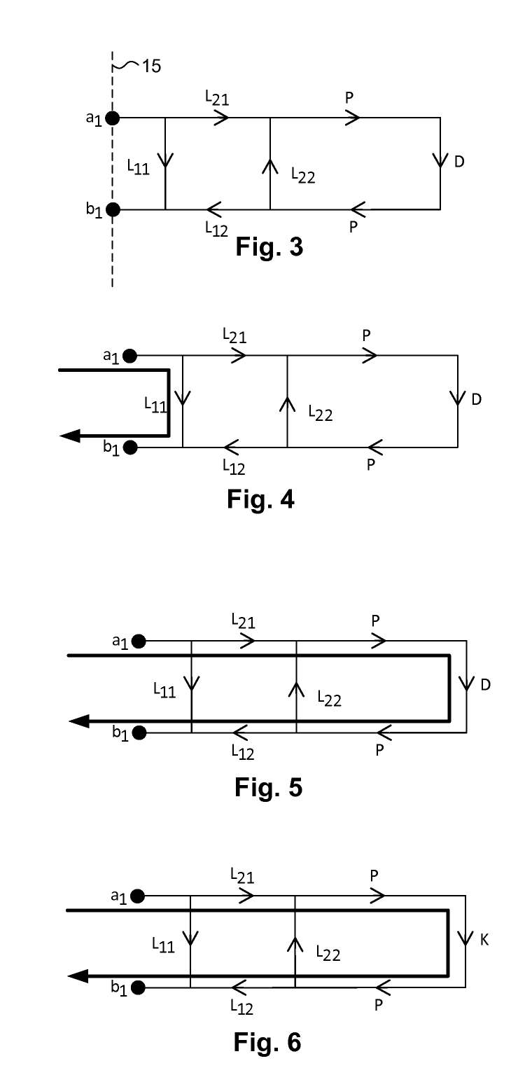

FIG. 3 is a general signal flow model of the intervening physical elements between the measurement points at a1 and b1 (known as the “reference plane”) and the DUT location at D. The intervening elements are modeled as L, a two port network, and P, a transmission line. This general model fits many actual measurement scenarios.

FIG. 4 illustrates that the first impulse response in time arises from the L₁₁ path. The equation for S11 of the path shown in FIG. 4 is:

$${S}_{11} = \frac{{b}_{1}}{{a}_{1}} = {L}_{11} \qquad ( 2 )$$

This first impulse response does not include the device D and, while it characterizes one aspect of the intervening circuitry, does not help with the measurement of the device.

FIG. 5 illustrates that the second impulse response in time arises from a path which includes the device D. The equation of S₁₁ for the path shown in FIG. 5 is:

$${S}_{11} = \frac{{b}_{1}}{{a}_{1}} = {L}_{12} {L}_{21} {P}^{2} D \qquad ( 3 )$$

Notably, equation (3) is relatively simple compared with equation (1).

Isolating the S-parameter response to the second impulse response involves a series of steps. First, the VNA tests the DUT with several regularly spaced frequencies in order to facilitate a transform to the time domain.

Second, the frequency domain responses measured by the VNA are transformed, using inverse Fourier transforms, into time domain responses. This step, in the context of VNAs, is known as “Time Domain Processing.” The form of the inverse Fourier transform used can be a Discrete Fourier Transform, a Fast Fourier Transform or a Chirp-Z Transform. Various shapes of windowing functions can be applied to the frequency domain data before it is transformed, in order to control certain behaviors of the resulting time domain responses. These behaviors include sidelobe level, sidelobe roll-off rate and time domain resolution.

Third, the part of the time domain response corresponding to the propagation path that includes D is gated and forward transformed back to the frequency domain. This processing step is known as “Frequency Gated By Time,” and yields a frequency domain response—for example, the S₁₁ of equation (3)—that represents only the selected part of the time domain response. Various methods for performing this forward Fourier transform may be used.

The frequency domain responses measured by a VNA are more generally known as transfer functions. The time domain responses computed from these transfer functions are more generally known as impulse response functions. The frequency gated by time responses computed by selecting a portion of the impulse response functions and transforming back to the frequency domain are, again, transfer functions. However, these transfer functions are based on only a portion of the total impulse response of the DUT. By careful selection of which parts of the impulse response are used in the computation of the transfer function, the transfer function for different propagation paths within the device under test can be determined.

The application of time domain processing as set forth above selects one path from the network and, therefore, simplifies the mathematical equivalent for the measurement (see equation (3)). The relative simplicity of this equation facilitates a more straightforward determination of the transfer function for the device D.

Another key aspect of the present invention is to substitute a known device K for D, as shown in FIG. 6, and make another measurement. The equation of S₁₁ for the path shown in FIG. 6 is

$${S}_{11} = \frac{{b}_{1}}{{a}_{1}} = {L}_{12} {L}_{21} {P}^{2} K \qquad ( 4 )$$

In order to avoid confusion, the S₁₁ measured when D is in place will hereinafter be referred to as M1. Also, the S₁₁ measured when K is in place will hereinafter be referred to as M2. Thus, equations 3 and 4 can be rewritten as equations 5 and 6, respectively:

M1=L₁₂L₂₁P²D (5)

M2=L₁₂L₂₁P²K (6)

Dividing equation 5 by equation 6 yields

$$\frac{M 1}{M 2} = \frac{D}{K} \qquad ( 7 )$$

Notably, the parts in common for the two measurements cancel. Equation 7 now contains two values, M1 and M2, which are both determined by measurements. The value K is assumed to be known. Thus, equation 7 can be solved for D as

$$D = \frac{M 1}{M 2} K \qquad ( 8 )$$

Thus, the value for D has been determined by two measurements, one with device D in place, and one with a single known device K in place. Because this method involves time domain processing and the substitution of K for D, this method is herein given the name of “Time Domain Substitution.”

In many practical situations, the unknown device D can be replaced with a known device K simply by short circuiting the input to the device D. Thus, one suitable known device K is a short circuit of the input to device D. Another possibility for the known device K is an open circuit.

Another aspect of the present invention is the recognition that the signal flow graph shown in FIG. 3 need not precisely represent the actual measurement scenario. No matter which path is chosen, the path equations will always be defined as strings of products. For example, a later reflection that involves two or more passes through the location of D could be used to compare D and K. If the path includes the DUT location twice, the value D can be found from

$${D}^{2} = \frac{M 1}{M 2} {K}^{2} \qquad ( 9 )$$

Paths with even more passes past the location of the DUT will result in higher powers of D and K, but can still be solved by extension of this approach. In short, all that is required is the equivalent representation be correct as to the power of D and K.

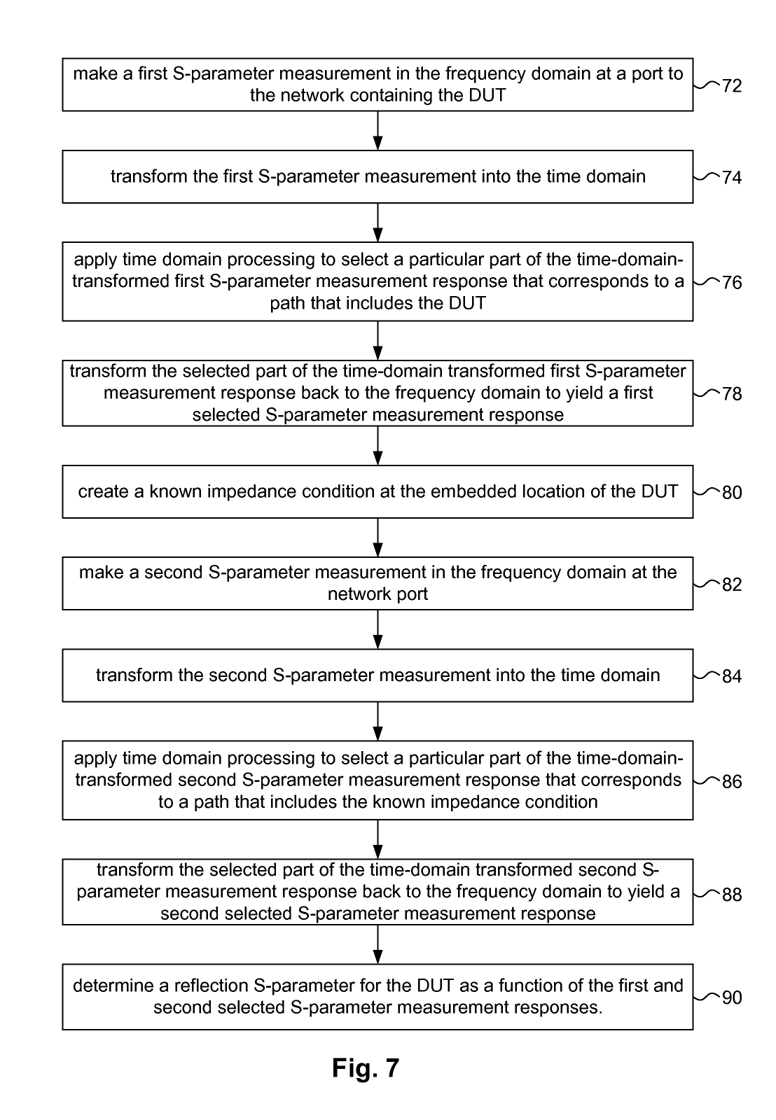

FIG. 7 is a flow chart of one embodiment of a method of de-embedding the S-parameter response of an electrical DUT embedded in an electrical network. In function block 72, a VNA is used to perform a first S-parameter measurement S₁₁, in the frequency domain, at a port to the network containing the DUT. In function block 74, the first S-parameter measurement is transformed into the time domain using a DFT, FFT, or Chirp-Z transform. In function block 76, time domain processing is applied to select a particular part of the time-domain-transformed first S-parameter measurement response that corresponds to a path that includes the DUT. The impulse response representing the DUT in the time domain trace is selected as in normal Frequency Gated by Time processing. In function block 78, the selected part of the time-domain transformed first S-parameter measurement response is transformed back to the frequency domain, using a suitable transform such as DFT, FFT, or Chirp-Z, to yield a first selected or isolated S-parameter measurement response. This frequency domain trace is denoted as M1.

In function block 80, a known impedance condition is created at the embedded location of the DUT. This may be done by applying a short at the location of the DUT, or by replacing the DUT with a known device having a S₁₁ as a function of frequency denoted by K. In function block 82, the VNA is used to make a second S-parameter measurement S₁₁, in the frequency domain, at the same network port referenced in function block 72. In function block 84, the second S-parameter measurement is transformed into the time domain using a DFT, FFT, or Chirp-Z transform. In function block 86, time domain processing is applied to select a particular part of the time-domain-transformed second S-parameter measurement response that corresponds to a path that includes the known impedance condition. In function block 88, the selected part of the time-domain transformed second S-parameter measurement response is transformed back to the frequency domain, again using a suitable transform such as DFT, FFT, or Chirp-Z, to yield a second selected or isolated S-parameter measurement response. This frequency domain trace is denoted M2.

In function block 90, a reflection S-parameter for the DUT, denoted as D, is determined as a function of the first and second selected S-parameter measurement responses M1 and M2. Equations 8 and 9 are each representative of such a function.

It will be understood that several variations can be applied to the process without departing from the spirit and scope of the invention. For example, the processing used to generate responses in the time domain, select a part of the time domain and transform back to the frequency domain, may be a Frequency Gated By Time processing, such as that available in the time domain processing of a VNA. Alternatively, this processing may be based on spectrographic processing. The impulse response selected by gating could be the first, second, third or any impulse response in the time domain. The known impedance condition or known device could be a short circuit or an open circuit. The DUT could be a one-port device, or merely one port of a multi-port device. The VNA making measurements could be either uncalibrated or calibrated using a previous calibration process.

Although the foregoing specific details describe various embodiments of this invention, persons reasonably skilled in the art will recognize that various changes may be made in the details of the method and apparatus of this invention without departing from the spirit and scope of the invention as defined in the appended claims. Therefore, it should be understood that, unless otherwise specified, this invention is not to be limited to the specific details shown and described herein.

I claim:

1. A method of de-embedding the scattering parameter (S-parameter) response of an electrical device under test (DUT) embedded in an electrical network, the method comprising:
making a first S-parameter measurement in the frequency domain at a port to the network containing the DUT;
transforming the first S-parameter measurement into the time domain;
applying time domain processing to select a particular part of the time-domain-transformed first S-parameter measurement response that corresponds to a path that includes the DUT;
transforming the selected part of the time-domain-transformed first S-parameter measurement response back to the frequency domain to yield a first selected S-parameter measurement response;
creating a known impedance condition at the embedded location of the DUT;
making a second S-parameter measurement at the port to the network having a known impedance condition at the location of the DUT;
transforming the second S-parameter measurement into the time domain;
applying time domain processing to select a particular part of the time-domain-transformed second S-parameter measurement response that corresponds to the path that includes the known impedance condition;
transforming the selected part of the time-domain-transformed second S-parameter measurement response back to the frequency domain to yield a second selected S-parameter measurement response; and
determining a reflection S-parameter for the DUT as a function of the first and second selected S-parameter measurement responses.

2. The method of claim 1, wherein the electrical network comprises a one-port network.

3. The method of claim 1, wherein the electrical network comprises a multi-port network.

4. The method of claim 1, wherein the electrical network comprises a transmission line.

5. The method of claim 1, wherein the reflection S-parameter is a function of a ratio between the first and second selected S-parameter measurement responses.

6. The method of claim 5, wherein the reflection S-parameter is a function of a ratio of the first selected S-parameter measurement response over the second selected S-parameter measurement response.

7. The method of claim 1, wherein the known impedance condition is a short.

8. The method of claim 1, wherein the known impedance condition is an open circuit.

9. The method of claim 1, further comprising reviewing a time domain trace of the time-domain-transformed first S-parameter measurement response to identify distinct propagation paths for the response.

10. The method of claim 1, wherein vector network analyzer (VNA) time domain processing is applied to gate a time domain portion of the time-domain-transformed first S-parameter measurement response corresponding to one of a plurality of identifiable propagation paths for the measurement response.

11. The method of claim 1, further comprising using spectrographic processing to select the particular part of the time-domain-transformed first S-parameter measurement response that corresponds to a path that includes the DUT.

12. The method of claim 1, wherein a calibrated vector network analyzer (VNA) is connected to the port of the electrical network in which the DUT is embedded and using the VNA to make the first and second S-parameter measurements.

13. The method of claim 1, wherein an uncalibrated vector network analyzer (VNA) is connected to the port of the electrical network in which the DUT is embedded and using the VNA to make the first and second S-parameter measurements.

14. A method of de-embedding the scattering parameter (S-parameter) response of an electrical device under test (DUT) embedded in a two-port electrical network, the method comprising:
making a first S-parameter measurement in the frequency domain at a port to the network containing the DUT;
transforming the first S-parameter measurement into the time domain;
applying time domain processing to select a particular part of the time-domain transform of the first S-parameter measurement that correspond to a path that includes the DUT;
transforming the selected part of the time-domain transform of the first S-parameter measurement back to the frequency domain to yield a selected S-parameter measurement response M1;
creating a known impedance condition at the embedded location of the DUT;
making a second S-parameter measurement at the port to the network having a known impedance condition at the location of the DUT;
transforming the second S-parameter measurement into the time domain;
applying time domain processing to select a particular part of the time-domain transform of the second S-parameter measurement that corresponds to a path that includes the known impedance condition;
transforming the selected part of the time-domain transform of the second S-parameter measurement back to the frequency domain to yield a selected S-parameter measurement response M2; and
determining a reflection S-parameter D for the DUT by the relationship:
D=K*M1/M2
wherein D is the reflection S-parameter and K is a known one-port standard.
